(19) United States
(12) Patent Application Publication
(10) Pub. No.: US 2014/0300288 A1
(43) Pub. Date: Oct. 9, 2014

(54) LIGHT EMITTING DEVICE POWER SUPPLY CIRCUIT AND DAMPING CIRCUIT THEREIN AND DRIVING METHOD THEREOF

(71) Applicants: Chien-Yang Chen, Taipei (TW); Chi-Hsiu Lin, Erlun Township (TW); Yi-Wei Lee, Taipei (TW)

(72) Inventors: Chien-Yang Chen, Taipei (TW); Chi-Hsiu Lin, Erlun Township (TW); Yi-Wei Lee, Taipei (TW)

(73) Assignee: RICHTEK TECHNOLOGY CORPORATION, Zhubei City (TW)

(21) Appl. No.: 14/223,922

(22) Filed: Mar. 24, 2014

Related U.S. Application Data
(60) Provisional application No. 61/808,548, filed on Apr. 4, 2013.

(51) Int. Cl. H05B 33/08

(52) U.S. Cl. CPC H05B 33/0815
USPC 315/200 R; 315/224

(57) ABSTRACT

The present invention discloses a light emitting device power supply circuit and a damping circuit therein and a driving method thereof. The light emitting device power supply circuit includes: a tri-electrode AC switch (TRIAC) dimming circuit, a rectifier circuit, a light emitting device driver circuit, and a damping circuit. The damping circuit includes: an impedance circuit, which is electrically connected between the rectifier circuit and the light emitting device driver circuit; a silicon control rectifier (SCR) circuit, which is connected to the impedance circuit in parallel; and a delay circuit, which is coupled to the SCR circuit, for turning ON the SCR circuit after a delay time period from when the TRIAC diming circuit begins to start-up, wherein the delay circuit does not directly receive a full scale of the input voltage.

### CROSS REFERENCE

The present invention claims priority to U.S. provisional application No. 61/808,548, filed on Apr. 4, 2013.

### BACKGROUND OF THE INVENTION

1. Field of Invention

The present invention relates to a light emitting device power supply circuit, and a damping circuit therein and a control method thereof. Particularly, it relates to such light emitting device power supply circuit which includes an active damping circuit, a control method thereof, and the active damping circuit.

2. Description of Related Art

FIG. 1A shows a schematic diagram of a prior art light emitting diode (LED) power supply circuit 100. As shown in FIG. 1A, the LED power supply circuit 100 includes a tri-electrode AC switch (TRIAC) dimming circuit 12, a rectifier circuit 14, an input capacitor Cin, and an LED driver circuit 16. The TRIAC dimming circuit 12 receives an AC voltage. When the AC voltage exceeds a predetermined trigger phase, the TRIAC dimming circuit 12 fires (starts-up) and turns ON. FIG. 1B shows a schematic diagram of waveforms of the AC voltage and an AC dimming voltage generated by the TRIAC dimming circuit 12. The AC voltage is shown by a dash line, and the AC dimming voltage generated by the TRIAC dimming circuit 12 is shown by a solid line. The rectifier circuit 14 receives the AC dimming voltage, and rectifies it to generate an input voltage Vin and an input current Iin which are inputted to the LED driver circuit 16 for driving the LED circuit 11 and adjusting its brightness. The LED driver circuit 16 converts the input voltage Vin to an output voltage Vout, and provides an output current to the LED circuit 11. In the aforementioned circuit, the function of the TRIAC dimming circuit 12 is to determine a trigger phase of the AC dimming voltage for adjusting an average brightness of the LED circuit 11. The LED driver circuit 16 includes a power stage circuit which has at least one power switch. The power stage circuit may be a synchronous or asynchronous buck, boost, inverting, buck-boost, inverting-boost, or flyback power stage circuit as shown in FIGS. 2A-2K.

One of the drawbacks of the aforementioned prior art is that the TRIAC dimming circuit 12 includes a TRIAC device, and the TRIAC device requires a large latching current to fire (start-up) in every cycle; however, after the TRIAC dimming circuit 12 starts up and the LED circuit 11 is turned ON, the normal operation current required to maintain conduction of the LED circuit 11 (i.e., the holding current) is small. If what the power supply drives is a high power consuming load circuit, such as a conventional incandescent lamp, one does not need to concern about the latching current because the normal operation current of an incandescent lamp is sufficient to start up the TRIAC device. However if what the power supply drives is a low power consuming load circuit, such as the LED circuit 11, the normal operation current of the LED circuit 11 (i.e., the holding current) is insufficient to start up the TRIAC device. If the power supply circuit does not generate a sufficient latching current to fire the TRIAC device, a so-called “misfire” occurs and the LED circuit 11 will flicker perceptibly. FIG. 1C shows the waveforms of the AC voltage and the AC dimming voltage when the misfire condition occurs. On the other hand, even though the latching current is sufficient to fire the TRIAC device, the misfire may still occur if the waveform of the latching current is not proper (e.g., if the latching current has a ringing waveform).

FIG. 3 shows a schematic diagram of another prior art LED power supply circuit 200, which solves the misfire problem of the aforementioned prior art. Different from the prior art LED power supply circuit 100 shown in FIG. 1A, the prior art LED power supply circuit 200 shown in FIG. 3 further includes a delay circuit 17 and a passive impedance circuit 18 (such as a resistor as shown in FIG. 3), for receiving the input voltage Vout and damping spikes of the aforementioned latching current by the impedance circuit 18 during every cycle when the TRIAC dimming circuit 12 is starting up, such that the TRIAC dimming circuit 12 may start-up smoothly and that the spikes or ringing of the input current does not false trigger the TRIAC dimming circuit 12.

FIGS. 4A and 4B show signal waveforms of the input voltage Vin and the input current Iin of the prior art LED power supply circuit 200. As shown in the figures, at the trigger phase, the input current Iin is relatively higher. The relatively higher input current Iin indicates a current consumed by the TRIAC dimming circuit 12 to fully start-up. Although the prior art the prior art LED power supply circuit 200 shown in FIG. 3 solves the misfire problem and hence solves the flicker problem of the LED circuit, the passive impedance circuit 18 continues consuming and wasting power after the TRIAC dimming circuit 12 has started up; besides unnecessary power consumption, the heat generated by the passive impedance circuit 18 as it continues consuming power may increase the operation temperature or even damage the circuitry. Further, because the delay circuit 17 is connected between a positive terminal and a negative terminal of the input voltage Vin, the delay circuit 17 requires to withstand a relatively higher voltage (a full swing of the input voltage Vin), and the cost thereof is higher.

In view of the foregoing, the present invention provides a light emitting device power supply circuit, and a damping circuit therein and a control method thereof to eliminate the drawbacks of the prior art. Particularly, the present invention provides an impedance circuit for damping the aforementioned current spikes to generate a proper latching current such that the TRIAC device is triggered to start-up properly. After the TRIAC dimming circuit is turned ON, the present invention provides a low impedance current channel which consumes low power. In addition, the present invention also reduces the cost of related devices because the devices require to withstand lower voltage.

### SUMMARY OF THE INVENTION

From one perspective, the present invention provides a light emitting device power supply circuit including: a tri-electrode AC switch (TRIAC) dimming circuit, for generating an AC dimming voltage according to an AC voltage; a rectifier circuit, which is coupled to the TRIAC dimming circuit, for generating an input voltage and an input current according to the AC diming voltage, wherein the input voltage is between a positive terminal and a negative terminal, and the input current inflows from the positive terminal; a light emitting device driver circuit, which is coupled to the rectifier circuit, and connected to an input capacitor in parallel, for converting the input voltage to an output voltage, and providing an output current to a light emitting device circuit; and a damping circuit, which is coupled between the rectifier circuit and the light emitting device driver circuit, the damping circuit including: an impedance circuit, which is electrically connected between the rectifier circuit and the light emitting device driver circuit; a silicon control rectifier (SCR) circuit, which is connected to the impedance circuit in parallel; and a delay circuit, which is coupled to the SCR circuit, for turning ON the SCR circuit after a delay time period from when the TRIAC diming circuit begins to start-up, wherein the delay circuit is not directly connected to both the positive side and the negative side of the input voltage.

In one embodiment, the delay circuit preferably includes: a resistor, having a first end connected to an anode of the SCR circuit; and a capacitor, which is connected between a second end of the resistor and a cathode of the SCR circuit.

In the aforementioned embodiment, the SCR circuit preferably includes a gate connected to the second end.

In one preferable embodiment, the input current flows through the impedance circuit when the TRIAC dimming circuit begins to start-up, and flows through the SCR circuit after the delay time period from when the TRIAC diming circuit begins to start-up.

From another perspective, the present invention provides a damping circuit in a light emitting device power supply circuit, the damping circuit being coupled between a rectifier circuit and a light emitting device driver circuit, wherein the rectifier circuit is couple to a tri-electrode AC switch (TRIAC) dimming circuit, for generating an input voltage and input current according to an AC dimming voltage generated by the TRIAC dimming circuit, wherein the input voltage is between a positive terminal and a negative terminal, and the input current inflows from the positive terminal, and wherein the light emitting device driver circuit is coupled to the rectifier circuit, and is connected to an input capacitor in parallel, for converting the input voltage to an output voltage, and providing an output current to a light emitting device circuit, the damping circuit comprising: an impedance circuit, which is electrically connected between the rectifier circuit and the light emitting device driver circuit; a silicon control rectifier (SCR) circuit, which is connected to the impedance circuit in parallel; and a delay circuit, which is coupled to the SCR circuit, for turning ON the SCR circuit after a delay time period from when the TRIAC diming circuit begins to start-up, wherein the delay circuit is not directly connected to both the positive side and the negative side of the input voltage.

In one preferable embodiment, the delay circuit includes: a resistor, having a first end connected to an anode of the SCR circuit; and a capacitor, which is connected between a second end of the resistor and a cathode of the SCR circuit.

In the aforementioned embodiment, the SCR circuit preferably includes a gate connected to the second end.

In one preferable embodiment, the input current flows through the impedance circuit when the TRIAC dimming circuit begins to start-up, and flows through the SCR circuit after the delay time period from when the TRIAC diming circuit begins to start-up.

From another perspective, the present invention provides a driving method of a light emitting device circuit, comprising: providing a tri-electrode AC switch (TRIAC) dimming circuit, for generating an AC dimming voltage according to an AC voltage; rectifying the AC dimming voltage to generate an input voltage and an input current, wherein the input voltage is between a positive terminal and a negative terminal, and the input current inflows from the positive terminal; converting the input voltage to an output voltage, and providing an output current to the light emitting device circuit; guiding the input current to flow through an impedance circuit when the TRIAC dimming circuit begins to start-up; providing a delay circuit, for delaying a time period from when the TRIAC diming circuit begins to start-up; and guiding the input current to flow through an SCR circuit after delaying a time period from when the TRIAC diming circuit begins to start-up; and wherein the impedance circuit and the SCR circuit are connected in parallel, and the delay circuit is not directly connected to both the positive side and the negative side of the input voltage.

In one preferable embodiment, the delay circuit includes: a resistor, having a first end connected to an anode of the SCR circuit; and a capacitor, which is connected between a second end of the resistor and a cathode of the SCR circuit.

In the aforementioned embodiment, the SCR circuit preferably includes a gate connected to the second end.

The objectives, technical details, features, and effects of the present invention will be better understood with regard to the detailed description of the embodiments below.

### BRIEF DESCRIPTION OF THE DRAWINGS

FIG. 1A shows a schematic diagram of a prior art light emitting diode (LED) power supply circuit 100.

FIGS. 1B and 1C show signal waveforms of the AC voltage and an AC dimming voltage generated by the TRIAC dimming circuit 12, wherein FIG. 1B shows that a sufficient latching current is generated for firing the TRIAC device, while FIG. 1C shows that the generated latching current is insufficient for firing the TRIAC device.

FIGS. 2A-2K show synchronous and asynchronous buck, boost, inverting, buck-boost, inverting-boost, and flyback power stage circuits.

FIG. 3 shows a schematic diagram of a prior art light emitting diode (LED) power supply circuit 200.

FIGS. 4A and 4B show waveforms of an input voltage Vin and an input current Iin in the LED power supply circuit 200, respectively.

FIG. 5 shows a first embodiment of the present invention.

FIG. 6 shows a second embodiment of the present invention.

FIG. 7 shows a thordd embodiment of the present invention.

FIG. 8 shows a fourth embodiment of the present invention

FIG. 9 shows waveforms of signals at different nodes of a light emitting device power supply circuit according to the present invention in operation.

### DESCRIPTION OF THE PREFERRED EMBODIMENTS

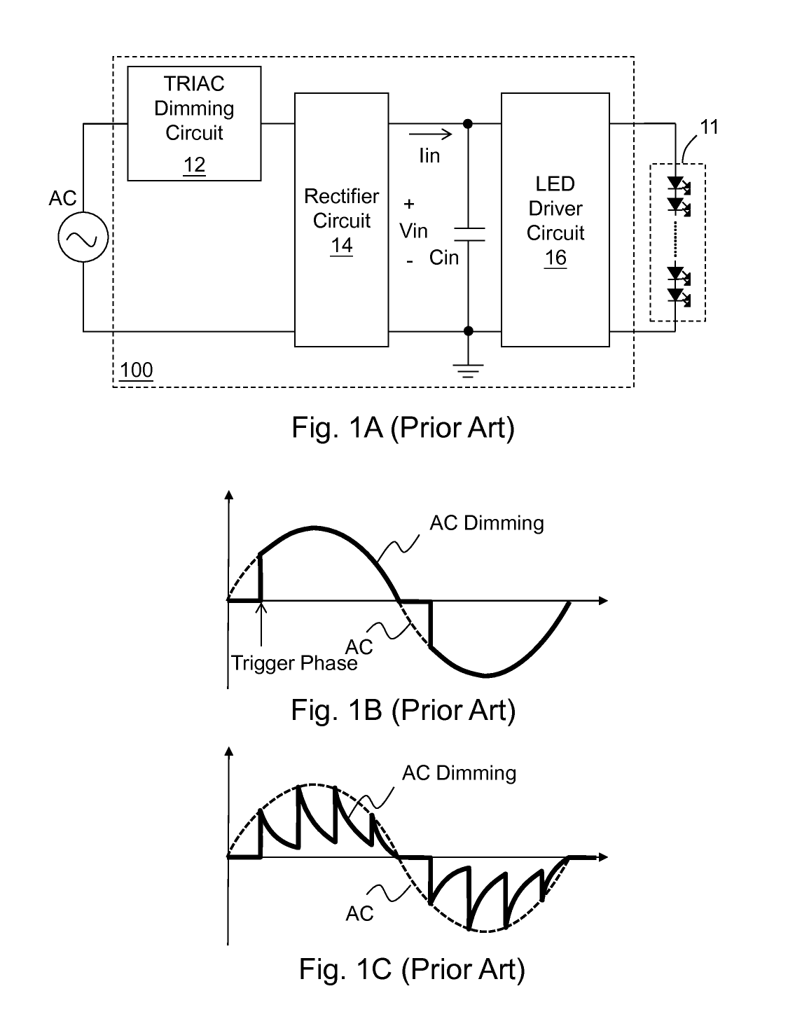

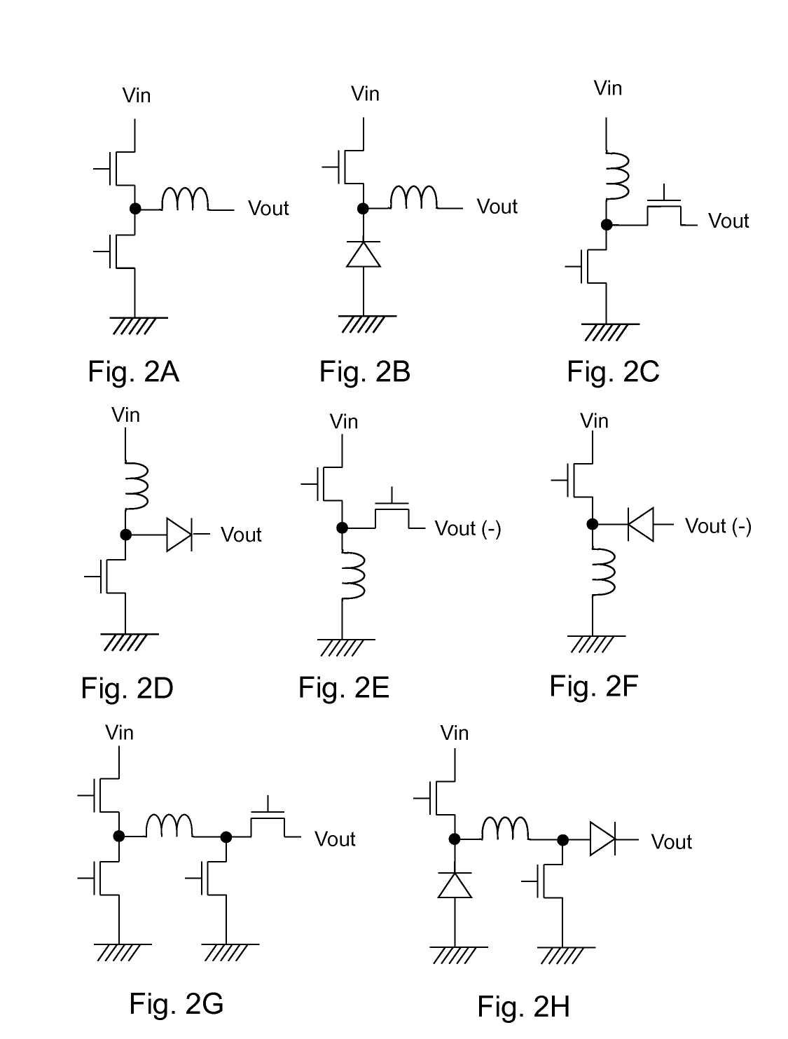

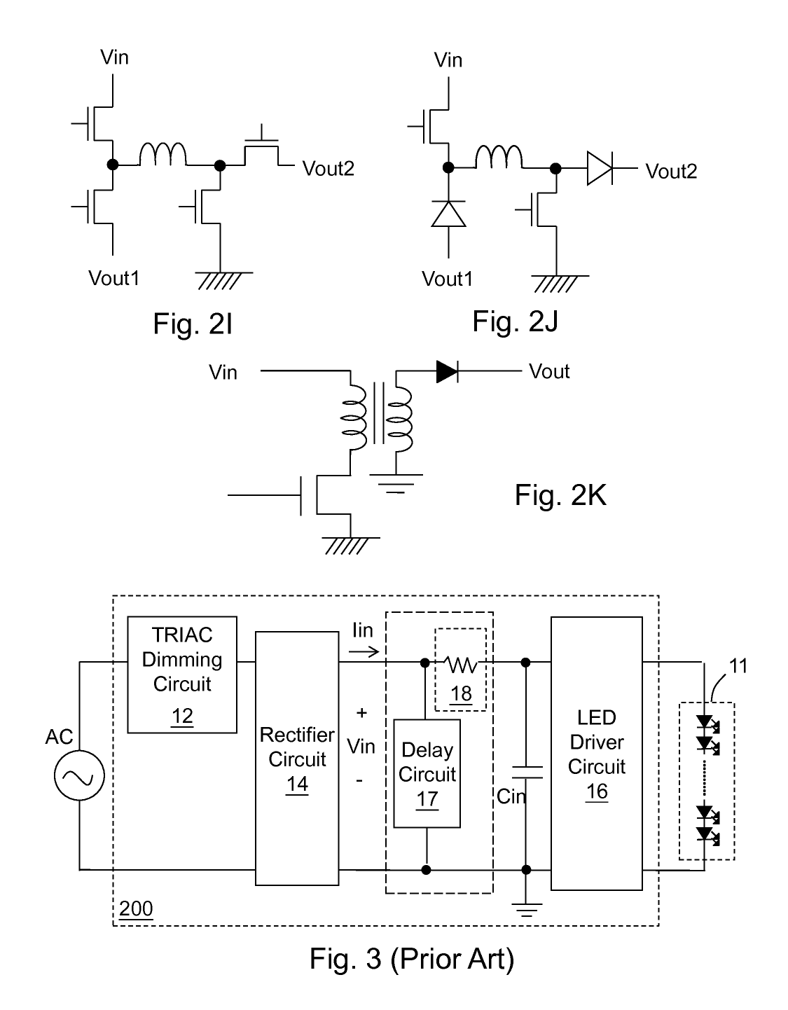

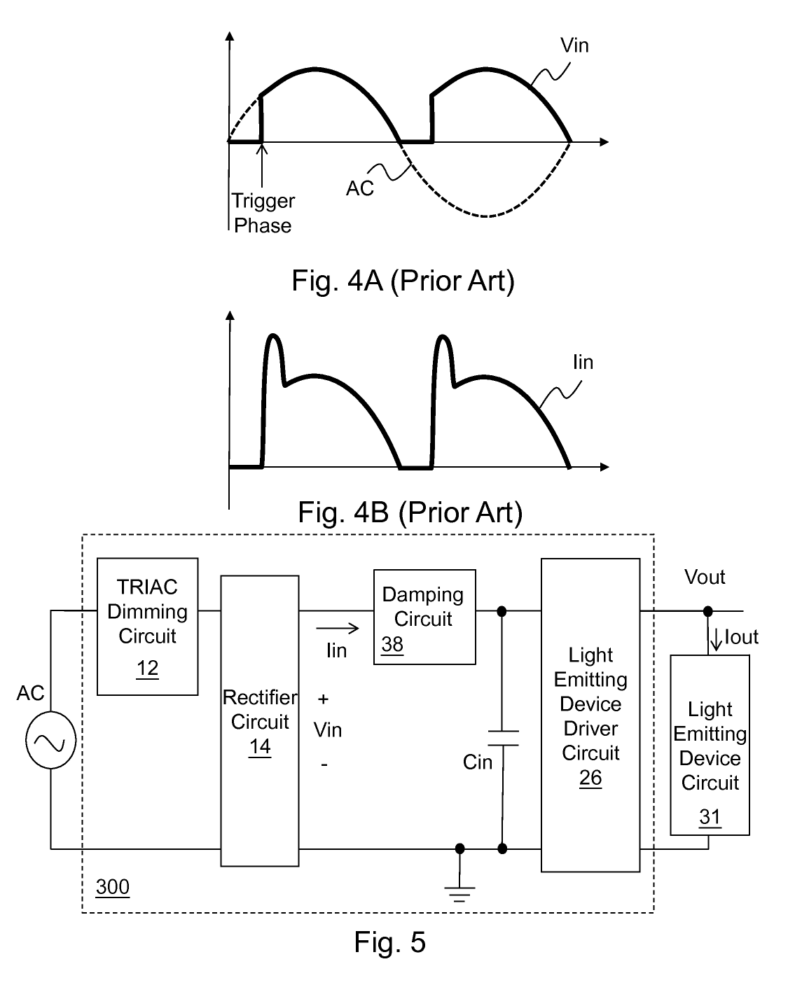

FIG. 5 shows a first embodiment of the present invention. As shown in the figure, a light emitting device power supply circuit 300 includes a tri-electrode AC switch (TRIAC) dimming circuit 12, a rectifier circuit 14, a light emitting device driver circuit 26, and a damping circuit 38. The TRIAC dimming circuit 12 generates an AC dimming voltage (having a signal waveform as shown by the solid line in FIG. 1B) according to an AC voltage (having a signal waveform as shown by the dash line in FIG. 1B). The rectifier circuit 14 is coupled to the TRIAC dimming circuit 12, for generating an input voltage Vin and an input current Iin according to the AC dimming voltage. The light emitting device driver circuit 26 is coupled to the rectifier circuit 14, and is connected to an input capacitor Cin in parallel. The light emitting device driver circuit 26 converts the input voltage Vin to an output voltage Vout, and provides an output current Tout to a light emitting device circuit 31. The light emitting device driver circuit 26 includes a power stage circuit for example but not limited to a power stage circuit shown in FIGS. 2A-2K. The light emitting device circuit 31 includes for example but not limited to a single LED string, or an LED array consisting of plural LED strings connected in parallel. The damping circuit 38 is coupled to the rectifier circuit 14 and the light emitting device circuit 26, for providing a current channel with a relatively higher resistance when the TRIAC dimming circuit 12 is starting-up (firing), such that a proper latching current can be generated, and providing a current channel with a relatively lower resistance after the TRIAC dimming circuit has started-up. Therefore, the aforementioned problems such as unnecessary power consumption and the damage because of heat in the prior art circuits, can be solved. The damping circuit 38 will be described in detail later.

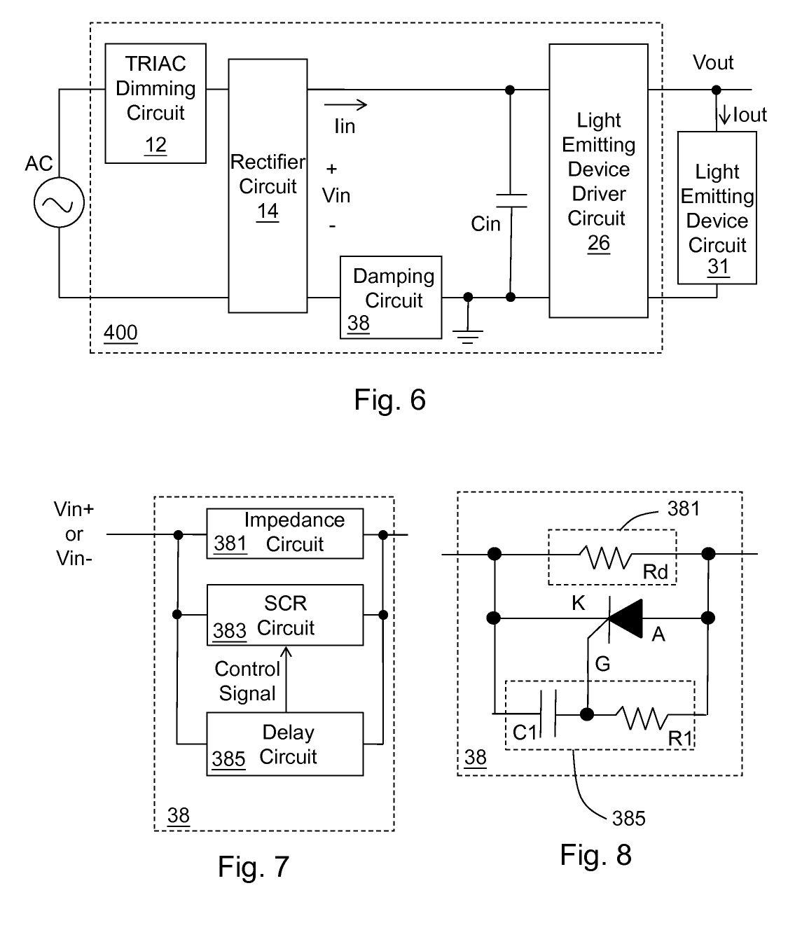

FIG. 6 shows a second embodiment of the present invention. This embodiment is different from the first embodiment in that, in this embodiment, the damping circuit 38 of a light emitting device power supply circuit 400 is connected to the negative terminal (low level side) of the input voltage Vin instead of the positive terminal (high level side) of the input voltage Vin as the first embodiment. Note that in the two embodiments, the damping circuit 38 is directly connected to at most one terminal of the input voltage Vin, but is not directly connected to both terminals of the input voltage Vin.

FIG. 7 shows a third embodiment of the present invention. This embodiment shows an embodiment of the damping circuit 38. As shown in the figure, the damping circuit 38 includes an impedance circuit 381, a silicon control rectifier (SCR) circuit 383, and a delay circuit 385. The impedance circuit 381 is electrically connected between the rectifier circuit 14 and the light emitting device driver circuit 26 (not shown, referring to FIG. 6). The SCR circuit 383 is connected to the impedance circuit 381 in parallel. The delay circuit 385 is coupled to the SCR circuit 383, for generating a control signal to turn ON the SCR circuit 383 after a delay time from when the TRIAC diming circuit 12 begins to start-up, wherein the delay circuit 385 is not directly connected across the positive terminal and the negative terminal of the input voltage Vin, that is, the delay circuit 385 is not directly connected to both the positive terminal and the negative terminal of the input voltage Vin; at most, the delay circuit 385 is only directly connected to either the positive terminal or the negative terminal of the input voltage Vin. In this embodiment, the delay circuit 385 does not turn ON the SCR circuit 383, which has a relatively lower resistance, for an initial time period (i.e. the delay time) from when the TRIAC diming circuit 12 begins to start-up, such that in the initial time period, the input current Iin (including the aforementioned latching current) flows through the impedance circuit 381, which has a relatively higher resistance, to start up the TRIAC dimming circuit 12 smoothly. After the initial time period from when the TRIAC diming circuit 12 begins to start-up, the delay circuit 385 changes the control signal so that the control signal turns ON the SCR circuit 382, and the input current Iin flows through the SCR circuit with the relatively lower resistance. As such, the TRIAC dimming circuit 12 can start-up smoothly by the relatively higher latching current, and the unnecessary power consumption in the prior art can be reduced after the TRIAC dimming circuit 12 has started-up.

Note that the delay circuit 385 is not directly connected to both the positive terminal and the negative terminal of the input voltage Vin, i.e., the delay circuit 385 does not receive a full-scale voltage of the input voltage Vin. Therefore, the components of the delay circuit 385 do not need to withstand the full-scale voltage of the input voltage Vin; the delay circuit 385 can be made with a lower cost and it will not be damaged because of the high voltage.

FIG. 8 shows a fourth embodiment of the present invention. This embodiment shows a more specific embodiment of the damping circuit 38. As shown in the figure, the impedance circuit 381 of the damping circuit 38 is for example but not limited to a resistor Rd. The SCR circuit 383 includes an anode A, a cathode K, and a gate G. The delay circuit 385 includes for example but not limited to a resistor R1 and a capacitor C1. The resistor R1 has a first end connected to the anode A of the SCR circuit 383, and a second end connected to the gate G of the SCR circuit 383. The capacitor C1 is connected between the second end of the resistor R1 (i.e., the gate G of the SCR circuit 383) and the cathode K of the SCR circuit 383. As shown in the figure, in this embodiment, the delay circuit 385 is connected to the impedance circuit 381 in parallel, to obtain a signal related to the start-up of the TRIAC dimming circuit 12, which is a voltage drop between two ends of the impedance circuit 381. When the TRIAC dimming circuit 12 is starting-up (i.e., from when it begins to start-up till when it has successfully started-up), the input current Iin (including the aforementioned latching current) is relatively higher, and the relatively higher input current Iin flows through the impedance circuit 381 to generate a relatively higher voltage drop between the two ends of the impedance circuit 381. By properly setting an RC constant of the RC circuit in the delay circuit 385, the SCR circuit 383 can be turned ON by the control signal after the TRIAC dimming circuit 12 has successfully started-up. After the SCR circuit 383 is turned ON, because the resistance of the SCR circuit 383 is lower than the impedance circuit 381, most of the input current Iin flows through the SCR circuit 383 to reduce the power consumption by the impedance circuit 381.

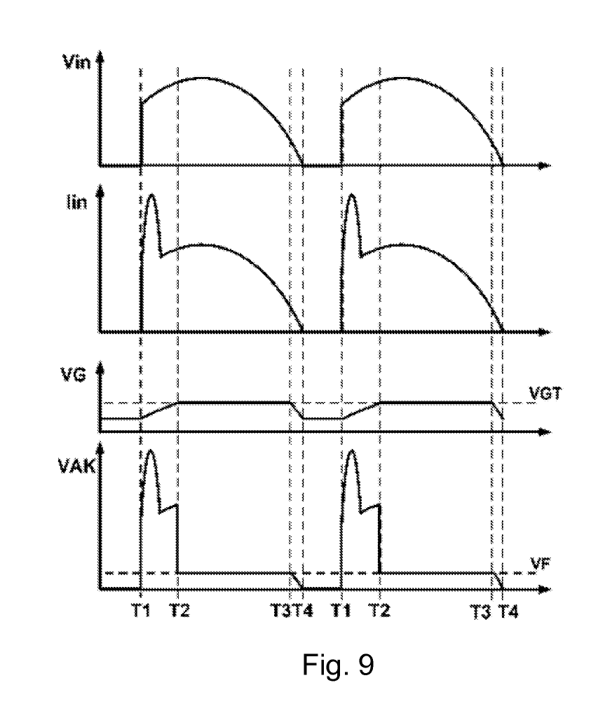

FIG. 9 shows waveforms of signals at different nodes of the light emitting device power supply circuit according to the present invention in operation. VG is the voltage at the gate G of the SCR circuit; VAK is the voltage drop between the anode A and the cathode K in the SCR circuit 383; VGT is the voltage required to trigger the SCR circuit 383 (in general, the trigger voltage of an SCR circuit is about 0.5V-0.8V); VF is the voltage drop between the anode A and the cathode K in the SCR circuit 383 when the SCR circuit 383 is turned ON (SCR conduction voltage). T1-T4 are marked time points.

Byway of example, referring to FIG. 8 and FIG. 9, the TRIAC dimming circuit 12 is triggered at time point T1, and the relatively higher input current Iin (including the aforementioned latching current) is generated. The relatively higher input current Iin flows through the resistor Rd, and the TRIAC dimming circuit 12 starts-up successfully before time point T2. In the meantime (from time point T1 to time point T2), the gate voltage VG increases, and the setting of the RC constant determines the time point when the gate voltage VG reaches the trigger voltage VGT. From time point T2 to time point T3, the gate voltage VG is kept at the trigger voltage VGT, and the TRIAC dimming circuit 12 is kept ON, so the input current Tin flows through the SCR circuit 383. In the meantime (from time point T2 to time point T3), the voltage drop between the anode A and the cathode K of the SCR circuit 383 is kept at the conductive voltage VF, so the power consumption is reduced. From time point T3 to time point T4, the input current Iin decreases to a level which can not keep the SCR circuit 383 conductive, so the SCR circuit 383 is turned OFF. In the meantime (from time point T3 to time point T4), the input current Iin flows through the impedance circuit 381, but the power consumption is low because the input current Iin is very low. From time point T4 to time point T1, the damping circuit 38 turns OFF, so the input current Iin is zero, and the SCR circuit 383 does not operate until next trigger phase.

The present invention has been described in considerable detail with reference to certain preferred embodiments thereof. It should be understood that the description is for illustrative purpose, not for limiting the scope of the present invention. Those skilled in this art can readily conceive variations and modifications within the spirit of the present invention. For example, a device which does not substantially influence the primary function of a signal can be inserted between two devices shown in direction connection in the shown embodiments, such as a switch or the like, so the term “couple” should include direct and indirect connections. For another example, the light emitting device that is applicable to the present invention is not limited to the LED as shown and described in the embodiments above, but may be any current-control device. For another example, the delay circuit is not limited to the RC circuit shown in the embodiments, but may be any circuit which can count a delay time to turn ON the current channel through the SCR circuit according to the start-up condition of TRIAC dimming circuit. In view of the foregoing, the spirit of the present invention should cover all such and other modifications and variations, which should be interpreted to fall within the scope of the following claims and their equivalents.

What is claimed is:

1. A light emitting device power supply circuit comprising:
a tri-electrode AC switch (TRIAC) dimming circuit, for generating an AC dimming voltage according to an AC voltage;
a rectifier circuit, which is coupled to the TRIAC dimming circuit, for generating an input voltage and an input current according to the AC diming voltage, wherein the input voltage is between a positive terminal and a negative terminal, and the input current inflows from the positive terminal;
a light emitting device driver circuit, which is coupled to the rectifier circuit, and connected to an input capacitor in parallel, for converting the input voltage to an output voltage, and providing an output current to a light emitting device circuit; and
a damping circuit, which is coupled between the rectifier circuit and the light emitting device driver circuit, the damping circuit including:
an impedance circuit, which is electrically connected between the rectifier circuit and the light emitting device driver circuit;
a silicon control rectifier (SCR) circuit, which is connected to the impedance circuit in parallel; and
a delay circuit, which is coupled to the SCR circuit, for turning ON the SCR circuit after a delay time period from when the TRIAC diming circuit begins to start-up, wherein the delay circuit is not directly connected to both the positive side and the negative side of the input voltage.

2. The light emitting device power supply circuit of claim 1, wherein the delay circuit includes:
a resistor, having a first end connected to an anode of the SCR circuit; and
a capacitor, which is connected between a second end of the resistor and a cathode of the SCR circuit.

3. The light emitting device power supply circuit of claim 2, wherein the SCR circuit includes a gate connected to the second end.

4. The light emitting device power supply circuit of claim 1, wherein the input current flows through the impedance circuit when the TRIAC dimming circuit begins to start-up, and flows through the SCR circuit after the delay time period from when the TRIAC diming circuit begins to start-up.

5. A damping circuit for use in a light emitting device power supply circuit, the damping circuit being coupled between a rectifier circuit and a light emitting device driver circuit, wherein the rectifier circuit is couple to a tri-electrode AC switch (TRIAC) dimming circuit, for generating an input voltage and input current according to an AC dimming voltage generated by the TRIAC dimming circuit, wherein the input voltage is between a positive terminal and a negative terminal, and the input current inflows from the positive terminal, and wherein the light emitting device driver circuit is coupled to the rectifier circuit, and is connected to an input capacitor in parallel, for converting the input voltage to an output voltage, and providing an output current to a light emitting device circuit, the damping circuit comprising:
an impedance circuit, which is electrically connected between the rectifier circuit and the light emitting device driver circuit;
a silicon control rectifier (SCR) circuit, which is connected to the impedance circuit in parallel; and
a delay circuit, which is coupled to the SCR circuit, for turning ON the SCR circuit after a delay time period from when the TRIAC diming circuit begins to start-up, wherein the delay circuit is not directly connected to both the positive side and the negative side of the input voltage.

6. The damping circuit of claim 5, wherein the delay circuit includes:
a resistor, having a first end connected to an anode of the SCR circuit; and
a capacitor, which is connected between a second end of the resistor and a cathode of the SCR circuit.

7. The damping circuit of claim 6, wherein the SCR circuit includes a gate connected to the second end.

8. The damping circuit of claim 5, wherein the input current flows through the impedance circuit when the TRIAC dimming circuit begins to start-up, and flows through the SCR circuit after the delay time period from when the TRIAC diming circuit begins to start-up.

9. A driving method of a light emitting device circuit, comprising:
providing a tri-electrode AC switch (TRIAC) dimming circuit, for generating an AC dimming voltage according to an AC voltage;
rectifying the AC dimming voltage to generate an input voltage and an input current, wherein the input voltage is between a positive terminal and a negative terminal, and the input current inflows from the positive terminal;
converting the input voltage to an output voltage, and providing an output current to the light emitting device circuit;
guiding the input current to flow through an impedance circuit when the TRIAC dimming circuit begins to start-up;
providing a delay circuit, for delaying a time period from when the TRIAC diming circuit begins to start-up; and
guiding the input current to flow through an SCR circuit after delaying a time period from when the TRIAC diming circuit begins to start-up; and
wherein the impedance circuit and the SCR circuit are connected in parallel, and the delay circuit is not directly connected to both the positive side and the negative side of the input voltage.

10. The driving method of claim 9, wherein the delay circuit includes:
a resistor, having a first end connected to an anode of the SCR circuit; and
a capacitor, which is connected between a second end of the resistor and a cathode of the SCR circuit.

11. The driving method of claim 10, wherein the SCR circuit includes a gate connected to the second end.
